(19) United States
(12) Patent Application Publication
(10) Pub. No.: US 2009/0321147 A1
(43) Pub. Date: Dec. 31, 2009

(54) TOUCH PANEL WITH PATTERNED LAYER

(75) Inventors: YU-CHOU YEH, TAOYUAN HSIEN (TW); CHUN-HUNG CHEN, TAOYUAN HSIEN (TW)

Correspondence Address: WPAT, PC;INTELLECTUAL PROPERTY ATTORNEYS, 7225 BEVERLY ST., ANNANDALE, VA, 22003, US

(73) Assignee: J TOUCH CORPORATION, TAOYUAN HSIEN (TW)

(21) Appl. No.: 12/199,108

(22) Filed: Aug. 27, 2008

(30) Foreign Application Priority Data
Jun. 30, 2008 (TW) 097124701

(51) Int. Cl. G06F 3/041

(52) U.S. Cl. 178/18.03

(57) ABSTRACT

The present invention discloses a touch panel with a patterned layer, the touch panel comprising: a patterned layer, a conductive film, spacers and a conductive glass. The patterned layer is capable of being directly attached onto the combined conductive layers and icons can be formed thereon. To further simplify the manufacturing process, the conductive film and the conductive glass are smaller than the patterned layer and can be as small as the active area of the patterned layer. The sizes of the conductive film and the conductive glass can be different. Moreover, at least a filler is provided and an adhesive is further provided between the combined conductive layers and the filler so that the mechanical strength of the whole structure is enhanced and there will be no warping or bending on the patterned layer.

### BACKGROUND OF THE INVENTION

1. Field of the Invention

The present invention generally relates to a touch panel with a patterned layer and, more particularly, to a touch panel with a patterned layer attached thereon so that the patterned layer is larger than the conductive film or the conductive glass and the touch panel can be manufactured with simplified processing.

2. Description of the Prior Art

The conventional touch panel 1 is as shown in FIG. 1 to comprises a first conductive film 11, a second conductive film 12, and a plurality of spacers 13 disposed between the first conductive film 11 and the second conductive film 12 to control the gap between the first conductive film 11 and the second conductive film 12. When the first conductive film 11 is warped due to an applied localized pressure, the first and the second conductive films contact each other and thus an electric connection is made to generate a potential difference for determining the position where the localized pressure is applied. The two conductive films 11 and 12 are combined and formed on a substrate 14. The substrate comprises glass or resin. The resin comprises polyethylene terephthalate (PET), polycarbonate (PC), polymethylmethacrylate (PMMA) or polyethylene naphthalate (PEN).

The touch panel has been widely used in various consumer electronic products, especially portable electronic products such as mobile phones, handsets, electronic calculators, gamers, personal digital assistants (PDA's), personal navigators, digital cameras and notebook computers. These products are designed to be thin and compact. Conventionally, the touch panels are mostly made by attaching two combined conductive layers onto a substrate made of glass or plastic. The glass substrate is rigid and exhibits strong resistance to impact; however, it is heavy. The plastic substrate also exhibits strong resistance to impact and is very durable. Even though the plastic substrate is lighter than the glass substrate, it is often made of polycarbonate (PC) with large birefringence or polymethylmethacrylate (PMMA) with water absorptivity and poor resistance to heat. Moreover, it is difficult to control the transparency of the conductive film and it often results in poor transparency. Therefore, the overall transparency will become very low if two combined conductive layers are attached onto a glass substrate or a plastic substrate.

Furthermore, the general electronic products are covered in a housing or a patterned layer (icon film), on which the icons for brand logos or function keys are printed. Conventionally, these icons are printed on a glass housing. More particularly, the housing or patterned layer is attached onto the touch panel and then a cutting process is performed. As a result, these four combined layers (i.e., the housing or the patterned layer, the two conductive films and the substrate) have the same shape and size. However, it is often that the housing or the patterned layer has a streamline style appearance by designing geometric patterns, chamfering or boring thereon, which leads to complexity and difficulty in manufacturing.

Therefore, there is need in providing a touch panel with a patterned layer that can be manufactured with simplified processing.

### SUMMARY OF THE INVENTION

The present invention provides a touch panel with a patterned layer. The touch panel comprises a conductive film, a conductive glass and a plurality of spacers disposed between the conductive film and the conductive glass to separate the conductive film and the conductive glass. When a localized pressure is applied, the conductive film and the conductive glass contact each other and thus an electric connection is made. Moreover, a patterned layer is directly attached onto the conductive film.

It is one object of the present invention to simplify the touch panel structure by replacing the conventional three-layered structure formed of a first conductive film and a second conductive film on a glass/plastic substrate with a two-layered structure formed of a conductive film and a conductive glass. Therefore, the touch panel is thinned and the transparency is enhanced.

More particularly, in the present invention, the two-layered structure is attached with a patterned layer comprising a display area and a non-display area. In the non-display area, icons for brand logos or function keys are printed on the patterned layer according to the designer's request. Moreover, the patterned layer has a streamline style appearance by designing geometric patterns, chamfering or boring thereon. Moreover, the display area comprises a view area (VA) and an active area (AA). The active area occupies most of the display area and is a pixel area located in the center portion whereon images are displayed. The view area is located around the active area whereon images are not displayed. The view area can also be an edge circuit area formed of surrounding electrodes for the touch panel. The size of the conductive film or conductive glass can be either identical to the size of the patterned layer or smaller than the size of the patterned layer without chamfering or boring on the edge of the conductive film or conductive glass. The conductive film or conductive glass can be as small as the active area. Therefore, the manufacturing process can be simplified and the material used for making the conductive film or conductive glass can be saved to reduce cost.

Moreover, since the patterned layer is larger than the combined conductive layers, a space region is formed between the combined conductive layers, the conductive glass and the patterned layer to cause creases and bending due to lack of support in the space region. The present invention uses a transparent resin as a filler to fill the space region, support the upper portion of the touch panel and enhance the mechanical strength of the whole structure. Moreover, an adhesive is provided between the lateral side of the combined conductive layers and the filler so that the lateral side of the combined conductive layers and the filler are adhered to each other. As a result, the mechanical strength of the whole structure is further enhanced and the patterned layer is more flattened without warping or bending.

It is another object of the present invention to simplify the touch panel structure by replacing the bottom conductive film and the glass/plastic substrate with a conductive glass. The conductive glass exhibits better resistance to heat and moisture than conventional conductive film formed of PET coated with an indium-tin oxide (ITO) film. Moreover, the conductive glass provides better support than the conventional conductive film formed on the plastic substrate to avoid warping or bending.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a cross-sectional diagram of a conventional touch panel;

FIG. 2 is a cross-sectional diagram of a touch panel with a patterned layer according to a first embodiment of the present invention;

FIG. 3 is a cross-sectional diagram of a touch panel with a patterned layer according to a second embodiment of the present invention;

FIG. 4 is a cross-sectional diagram of a touch panel with a patterned layer according to a third embodiment of the present invention;

FIG. 5 is a top view of a touch panel with a patterned layer according to the present invention;

FIG. 6 is a cross-sectional diagram of a touch panel with a patterned layer according to a fourth embodiment of the present invention;

FIG. 7 is a cross-sectional diagram of a touch panel with a patterned layer according to a fifth embodiment of the present invention;

FIG. 8 is a cross-sectional diagram of a touch panel with a patterned layer according to a sixth embodiment of the present invention;

FIG. 9 is a cross-sectional diagram of a touch panel with a patterned layer according to a seventh embodiment of the present invention;

FIG. 10 is a cross-sectional diagram of a touch panel with a patterned layer according to an eighth embodiment of the present invention;

FIG. 11 is a cross-sectional diagram of a touch panel with a patterned layer according to a ninth embodiment of the present invention;

FIG. 12 is a cross-sectional diagram of a touch panel with a patterned layer according to a tenth embodiment of the present invention;

FIG. 13 is a cross-sectional diagram of a touch panel with a patterned layer according to an eleventh embodiment of the present invention;

FIG. 14 is a cross-sectional diagram of a touch panel with a patterned layer according to a twelfth embodiment of the present invention; and

FIG. 15 is a cross-sectional diagram of a touch panel with a patterned layer according to a thirteenth embodiment of the present invention.

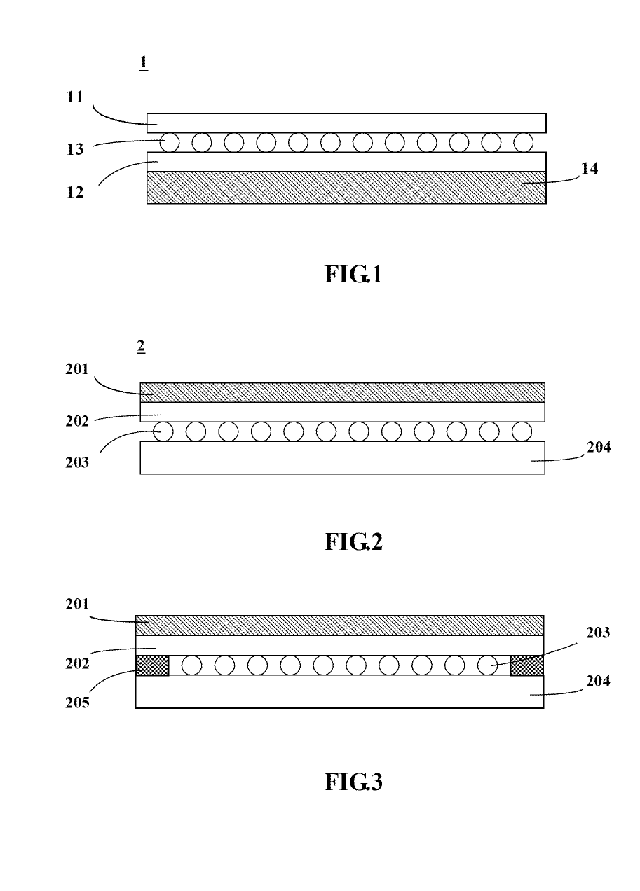

### DETAILED DESCRIPTION OF THE PREFERRED EMBODIMENT

The present invention can be exemplified by the preferred embodiments as described hereinafter.

Please refer to FIG. 2, which is a cross-sectional diagram of a touch panel with a patterned layer according to a first embodiment of the present invention. The touch panel 2 comprises: a patterned layer 201, a conductive film 202, a plurality of spacers 203 and a conductive glass 204. The conductive film 12 comprises a conductive material selected from a group consisting of indium oxide, antimony oxide, zinc oxide, cadmium oxide, silicon oxide, aluminum oxide, tin oxide and gallium oxide or combination thereof such as IZO, GZO, AZO, ATO, FTO and ITO. In a first embodiment of the present invention, an ITO conductive film 202 and an ITO conductive glass 204 are used to exemplify, but not to limit, the present invention, while other conductive films and conductive glasses can also be used without departing from the scope of the present invention.

Moreover, the plurality of spacers 203 are disposed between the conductive film 202 and the conductive glass 204 to separate the conductive film 202 and the conductive glass 204 to avoid a short circuit while not being touched that may lead to error function.

Moreover, the patterned layer 201 is disposed on the conductive film 202 to protect the touch panel as a housing, whereon the icons for brand logos or function keys are printed.

Please refer to FIG. 3, which is a cross-sectional diagram of a touch panel with a patterned layer according to a second embodiment of the present invention. A spacer layer 205 is provided on the boundary portion of the conductive film 202 and the conductive glass 204 to support the two combined conductive layers (i.e., the conductive film 202 and the conductive glass 204) to have a gap therebetween and attach the conductive film 202 and the conductive glass 204 on the boundary portion. The spacer layer 205 can be a double-sided adhesive layer, such as a double-sided pressure sensitive adhesive (PSA) or a liquid adhesive layer. However, the present invention is not limited thereto and other double-side adhesives can also be used.

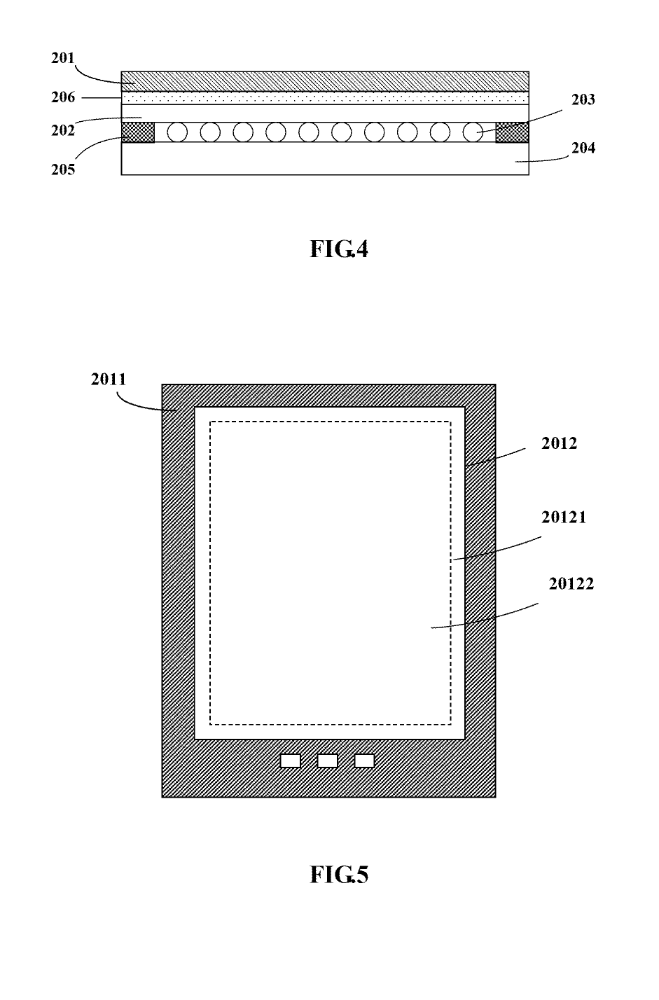

FIG. 4 is a cross-sectional diagram of a touch panel with a patterned layer according to a third embodiment of the present invention. An adhesive layer 206 is provided between the patterned layer 201 and the conductive film 202. The adhesive layer 206 uses an optical glue such as silicone or epoxy resin. The adhesive layer 206 can also use a photo-sensitive resin such as a UV glue. With the adhesive layer 206, the patterned layer 201 and the conductive film 202 is adhered to each other.

Please refer to FIG. 5, which is a top view of a touch panel with a patterned layer according to the present invention. The patterned layer 201 comprises a display area 2012 and a non-display area 2011. In the non-display area 2011, icons for brand logos or function keys are printed on the patterned layer. Moreover, geometric patterns, chamfering or boring can be formed on the boundary region of the non-display area 2011. Moreover, the display area 2012 comprises a view area (VA) 20121 and an active area (AA) 20122. The active area 20122 occupies most of the display area 2012 and is a pixel area located in the center portion whereon images are displayed. The view area 20121 is located around the active area 20122 whereon images are not displayed. The view area 20121 can also be an edge circuit area formed of surrounding electrodes for the touch panel.

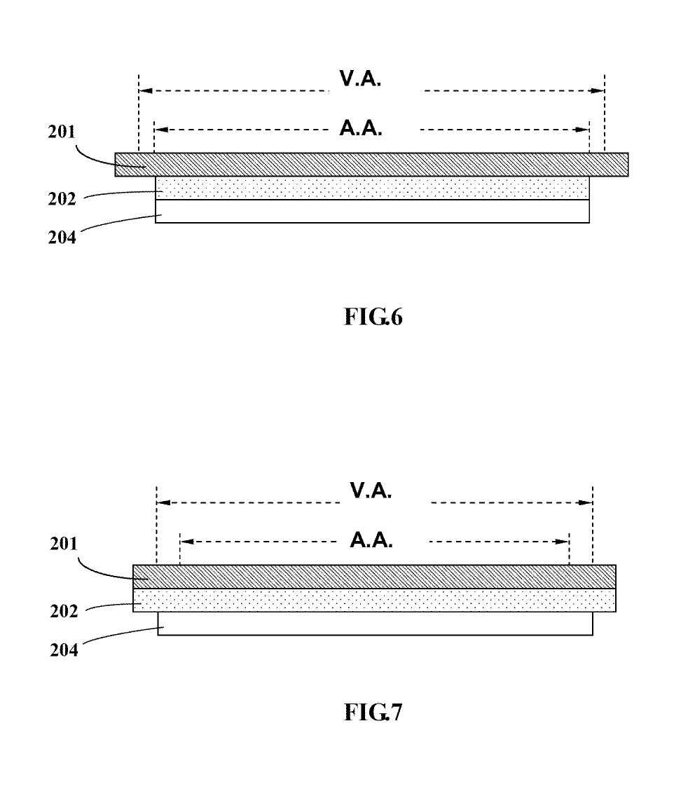

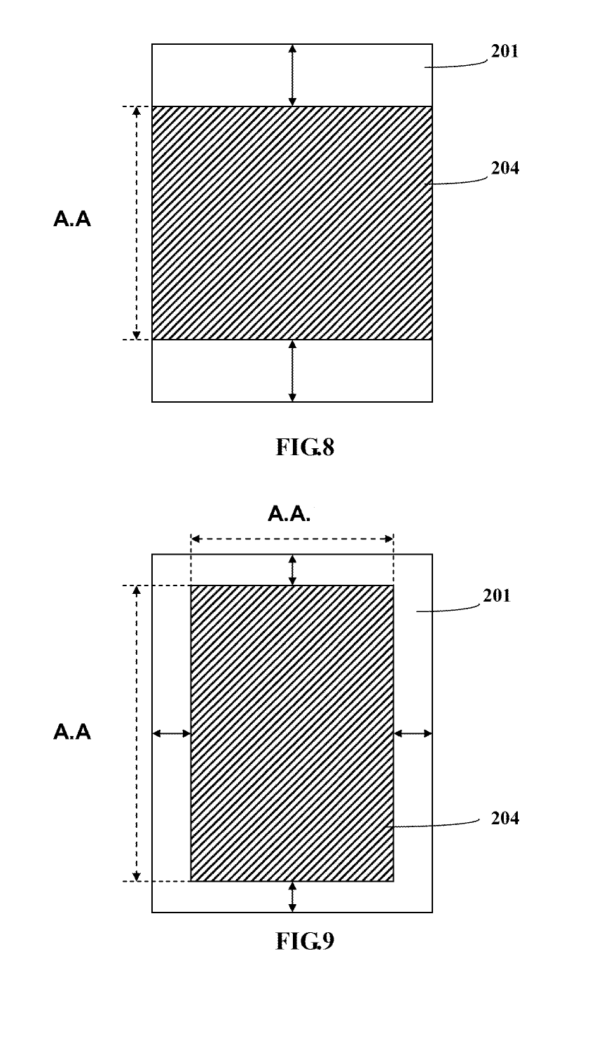

Please refer to FIG. 6, FIG. 7, FIG. 8 and FIG. 9. The shape of the non-display area 2011 can be varied, while the size of the conductive film 202 and conductive glass 204 is smaller than the patterned layer 201 or as small as the active area 20122 as long as they are functional. The size of the conductive film 202 and conductive glass 204 can be identical or non-identical (FIG. 7). Moreover, the patterned layer 201 and the conductive film 202/the conductive glass 204 are cut in different processes before the combined conductive layers are attached onto the patterned layer 201. In this manner, the manufacturing complexity is simplified with speeded up with lowered cost.

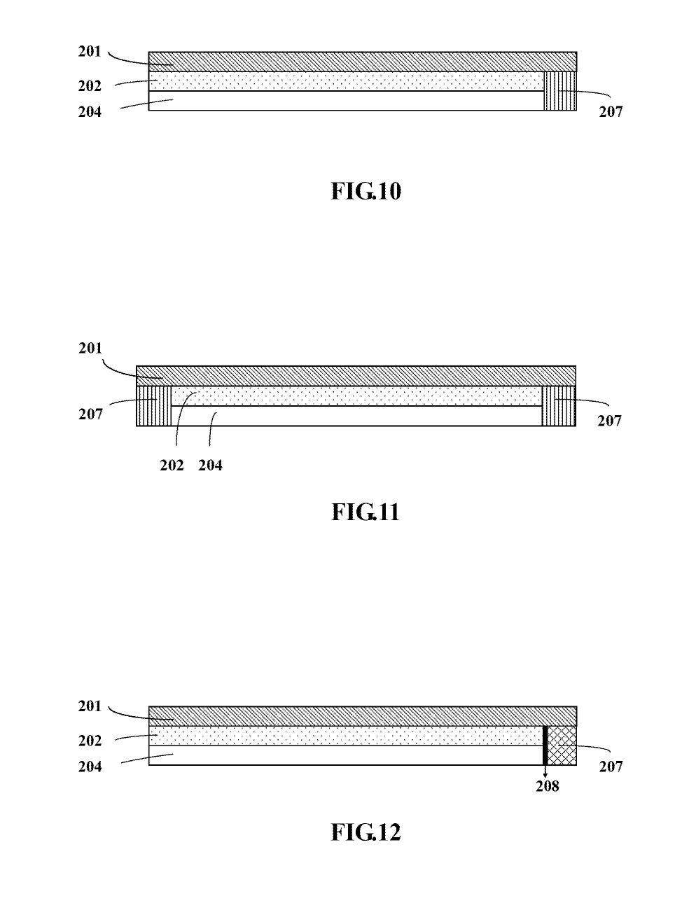

As shown in FIG. 10 and FIG. 11, at least a space region is formed between the combined conductive layers 202 and 204 and the patterned layer 201 to cause creases and bending on the patterned layer 201 due to lack of support because the size of the combined conductive layers 202 and 204 is smaller than the patterned layer 201. In the present invention, the space region can be filled by a portion of the housing or a first filler 207. FIG. 10 and FIG. 11 show a touch panel with a patterned layer according to two different embodiments of the present invention. The first filler 207 comprises a transparent resin comprises polycarbonate (PC), polyethylene terephthalate (PET), tri-acetyl cellulose (TAC), polymethylmethacrylate (PMMA), polyethylene naphthalate (PEN), polytrimethylene terephthalate (PTT), polyimide, polyether, polyamide, polyethylene (PE), polypropylene (PP), polyvinyl alcohol (PVA), polystyrene (PS), polyvinylchloride (PVC), epoxy resin, phenol formaldehyde resin or the like.

As shown in FIG. 12, a first filler 207 is provided on a common side of the conductive film 202 and conductive glass 204. Moreover, a first adhesive 208 is further provided between the common side and the first filler 207 so that the first filler 207 is adhered to the common side. Therefore, the mechanical strength of the whole structure is enhanced so that there will be no warping or bending on the patterned layer 201 that is more flattened.

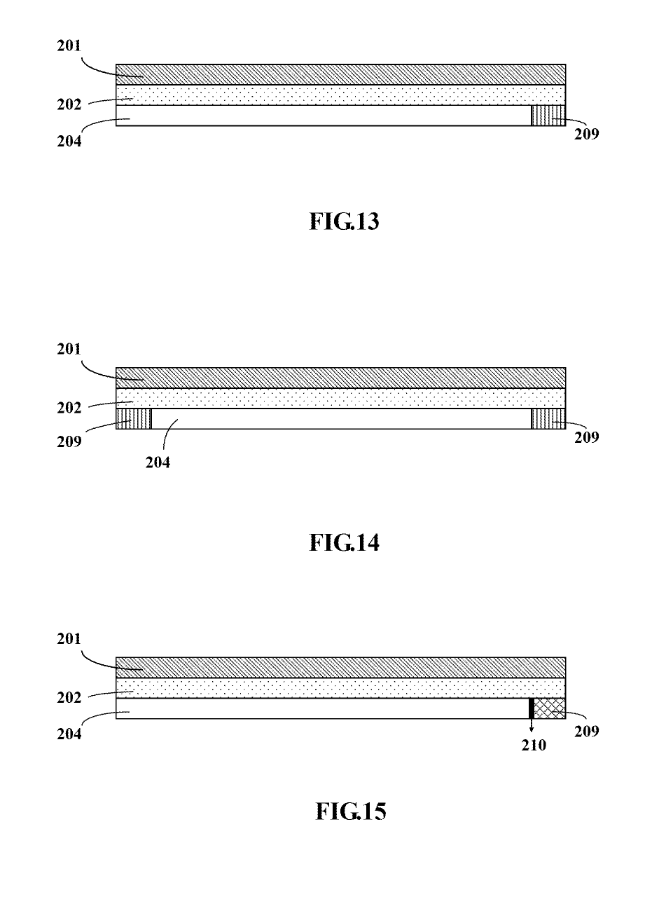

Please refer to FIG. 13, FIG. 14 and FIG. 15, which show modifications of the previous embodiments of the present invention. The conductive film 202 and the patterned layer 201 are cut flush so that the difference between the sizes of the conductive film 202 and the conductive glass 204 results in at least a space region. The space region can be filled with a second filler 209 comprises a transparent resin. Moreover, in FIG. 15, a second adhesive 210 is further provided between the conductive glass 204 and the second filler 209 so that the mechanical strength of the whole structure is enhanced and there will be no warping or bending on the patterned layer 201 and the conductive film 202 that are more flattened.

Accordingly, the present invention discloses a touch panel with a patterned layer attached thereon so that the touch panel can be manufactured with simplified processing. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A touch panel with a patterned layer, the touch panel comprising:
a patterned layer, having a display area and a non-display area;
a conductive film, being disposed under the patterned layer;
a conductive glass, being disposed under the conductive film; and
a plurality of spacers, being disposed between the conductive film and the conductive glass.

2. The touch panel with a patterned layer as recited in claim 1, wherein the conductive film comprises indium-tin oxide (ITO).

3. The touch panel with a patterned layer as recited in claim 1, wherein the conductive glass is an indium-tin oxide (ITO) conductive glass.

4. The touch panel with a patterned layer as recited in claim 1, wherein the display area of the patterned layer further comprises an active area and a view area.

5. The touch panel with a patterned layer as recited in claim 1, further comprising a spacer layer disposed on a boundary portion between the conductive film and the conductive glass.

6. The touch panel with a patterned layer as recited in claim 5, wherein the spacer layer is a double-sided adhesive layer or a liquid adhesive layer.

7. The touch panel with a patterned layer as recited in claim 1, further comprising an adhesive layer disposed between the patterned layer and the conductive film.

8. The touch panel with a patterned layer as recited in claim 7, wherein the adhesive layer comprises an optical glue or a UV glue.

9. The touch panel with a patterned layer as recited in claim 1, wherein the conductive glass is no larger than the patterned layer.

10. The touch panel with a patterned layer as recited in claim 4, wherein the conductive glass is no larger than the patterned layer.

11. The touch panel with a patterned layer as recited in claim 4, wherein the conductive glass is no smaller than the active area.

12. The touch panel with a patterned layer as recited in claim 1, further comprising a first filler on at least a common side of the conductive film and the conductive glass, the first filler being capable of filling a space region included by the common side and one side of the patterned layer.

13. The touch panel with a patterned layer as recited in claim 5, further comprising a first filler on at least a common side of the conductive film and the conductive glass, the first filler being capable of filling a space region included by the common side and one side of the patterned layer.

14. The touch panel with a patterned layer as recited in claim 7, further comprising a first filler on at least a common side of the conductive film and the conductive glass, the first filler being capable of filling a space region included by the common side and one side of the patterned layer.

15. The touch panel with a patterned layer as recited in claim 12, wherein the first filler comprises a transparent resin.

16. The touch panel with a patterned layer as recited in claim 15, wherein the transparent resin comprises polycarbonate (PC).

17. The touch panel with a patterned layer as recited in claim 12, further comprising a first adhesive between the first filler and at least a common side of the conductive film and the conductive glass.

18. The touch panel with a patterned layer as recited in claim 1, further comprising a second filler on at least one side of the conductive glass, the second filler being capable of filling a space region included by the one side and one side of the conductive film.

19. The touch panel with a patterned layer as recited in claim 5, further comprising a second filler on at least one side of the conductive glass, the second filler being capable of filling a space region included by the one side and one side of the conductive film.

20. The touch panel with a patterned layer as recited in claim 7, further comprising a second filler on at least one side of the conductive glass, the second filler being capable of filling a space region included by the one side and one side of the conductive film.

21. The touch panel with a patterned layer as recited in claim 18, wherein the second filler comprises a transparent resin.

22. The touch panel with a patterned layer as recited in claim 21, wherein the transparent resin comprises polycarbonate (PC).

23. The touch panel with a patterned layer as recited in claim 18, further comprising a second adhesive between the second filler and at least one side of the conductive glass.
